(19) United States
(12) Patent Application Publication
(10) Pub. No.: US 2003/0021665 A1
(43) Pub. Date: Jan. 30, 2003

(54) Containerized refuse collection truck

(75) Inventors: Nicholas Maglaras, Flushing, NY (US); Howard J. Feinstein, Oyster Bay Cove, NY (US); Leonard DiBari, Glendale, NY (US)

Correspondence Address: HOFFMANN & BARON, LLP, 6900 JERICHO TURNPIKE, SYOSSET, NY, 11791, US

(73) Assignee: Pack & Go Systems, LLC.

(21) Appl. No.: 10/254,287

(22) Filed: Sep. 25, 2002

Related U.S. Application Data
(63) Continuation-in-part of application No. 09/748,836, filed on Dec. 27, 2000.
(60) Provisional application No. 60/173,424, filed on Dec. 29, 1999.
(60) Provisional application No. 60/189,991, filed on Mar. 17, 2000.

(51) Int. Cl. B65F 3/00

(52) U.S. Cl. 414/525.2

(57) ABSTRACT

A containerized refuse collection truck that generally includes a cab having a chassis extending rearwardly therefrom, a compactor unit attached to a rear end of the chassis and a refuse container removably attached to the chassis between the cab and the compactor unit. The refuse container includes an inner door hingedly connected to the container above the refuse receiving opening. The compactor unit includes a hopper plate hingedly connected to a bottom portion of the compactor unit below the refuse receiving opening of the refuse container. The compactor unit also includes a first piston connected to the refuse container inner door for driving the inner door between an open position and a closed position and a second piston connected to the hopper plate for driving the hopper plate between a first position for receiving refuse on the hopper plate and a second position for loading refuse into the container refuse receiving opening. The container may also include a door self-locking and automatic release mechanism.

### CROSS-REFERENCE TO RELATED APPLICATIONS

This application is a continuation-in-part (CIP) of U.S. application Ser. No. 09/748,836, filed Dec. 27, 2000, which claims the benefit of U.S. Provisional Application No. 60/173,424, filed Dec. 29, 1999 and U.S. Provisional Application No. 60/189,991 filed Mar. 17, 2000.

### FIELD OF THE INVENTION

The present invention relates generally to a refuse collection vehicle and more particularly to a refuse collection truck having a removable refuse container for separate dumping of the refuse apart from the truck.

### BACKGROUND OF THE INVENTION

The conventional practice for municipal refuse collection services is to collect curbside garbage into a refuse collection truck where it is compacted into the body of the truck. When the truck is full it travels to a common refuse dumping site where the truck is emptied. The dumping site may be an intermediate dumping site, such as a dock for an open barge, or a final dumping site, such as a landfill. In either case, the site is typically remote from the truck's collection route. At intermediate sites, large payloaders often scoop up the deposited garbage and transfer it into large earthmover type trucks, which in turn convey the garbage or refuse to a barge or directly to the final dumping site.

One of the several disadvantages of the conventional system is the “down time” of the collection truck while the collection truck is in transit between its collection route and the common dumping site. In other words, the collection truck is no longer in service for collection while it is traveling to the dumping site. Furthermore, should a loaded truck break down for any reason, the refuse contents of the truck would have to be unloaded, often manually, before repairs could be undertaken. Another disadvantage of the conventional practice is the typical requirement for an intermediate dumping site for the individual collection trucks and the rather expensive equipment required for the intermediate dumping site to transfer the garbage to the next link of the disposal chain. Open dumping of refuse at common dumping sites also has the added unsanitary drawbacks of odors, spillage and the congregation of seagulls and vermin.

Accordingly, it is desirable to provide a refuse collection system, which minimizes the down time of the collection truck, eases loading and unloading of the truck and eliminates the problems associated with open intermediate dumping sites.

### SUMMARY OF THE INVENTION

The present invention is a containerized refuse collection truck including a conventional refuse collection truck cab and chassis but having a removable refuse container. When the collection truck of the present invention is full, the refuse container may be removed at a local transfer station and replaced with a new refuse container in a minimal amount of time so that the truck may continue its collection route with a minimum of down time. The full refuse containers may be then transported from the local transfer station to a landfill or barge by container carrying trucks or by rail. If transported to a barge, the container itself may be loaded onto the barge and conveyed to the final dumping site where it is emptied and returned to the local transfer station. When transporting containerized refuse, the problems associated with intermediate dumping sites and open barges are eliminated.

The containerized refuse collection truck of the present invention generally includes a cab having a chassis extending rearwardly therefrom, a compactor unit attached to a rear end of the chassis and a refuse container removably attached to the chassis between the cab and the compactor unit. The refuse container includes a door hingedly connected to a rear end of the container for swinging downwardly into the compactor unit in an open position. The door is driven by a piston of the compactor unit from its open position for receiving refuse on said door to a closed position for compacting the refuse within the container. The piston of the compactor unit may be removably connected to the door for driving the door directly or it may be connected to a driver door upon which the door is seated for driving the door between its open and closed positions.

In a preferred embodiment, the container door is hingedly connected to an outward swinging rear wall of the container, wherein the swinging rear wall of the container allows for emptying of the container. The refuse container also preferably includes an ejector assembly positioned within the container at a front end thereof for ejecting refuse within the container out through the rear end of the container. The ejector assembly preferably comprises a frame, an ejector piston connected at one end to the frame and an ejector blade connected to an opposite end of the ejector piston for pushing refuse rearwardly out through the rear end of the container. The frame is releasably fastened to the container such that the ejector assembly is removable from the container.

Preferably, the chassis further includes at least one lock cooperating with at least one correspondingly sized key-hole provided on the container for alternately securing and releasing the container. The container door further preferably includes upstanding walls forming a pocket for receiving the refuse on the door. The two upstanding side walls increase in height in a direction away from the hinged connection of the container door for aiding in the compaction of the refuse within the container.

In an alternative embodiment, the containerized refuse collection truck includes a cab having a chassis extending rearwardly from the cab, a refuse container removably attached to the chassis and a compactor unit attached to a rear end of the chassis. The refuse container includes a refuse receiving opening at a rear end thereof and an inner door hingedly connected to the container above the refuse receiving opening. The compactor unit includes a hopper plate hingedly connected to a bottom portion of the compactor unit below the refuse receiving opening of the refuse container. The compactor unit also includes a first piston connected to the refuse container inner door for driving the inner door between an open position and a closed position, thereby alternately opening and closing the refuse receiving opening of the refuse container. The compactor init further includes a second piston connected to the hopper plate for driving the hopper plate between a first position for receiving refuse on the hopper plate and a second position for loading refuse into the container refuse receiving opening.

The refuse container further preferably includes an outer door hingedly connected to a top portion of the rear end of the refuse container and the refuse container inner door is hingedly connected to the outer door. The refuse container inner door preferably includes a hook for detachable connection with the first piston of the compactor unit, wherein the hook faces downwardly away from the hinged connection of the inner door, whereby upon downward loading of the refuse container onto the chassis, the hook engages the first piston of the compactor unit.

Preferably, the compactor unit includes two first pistons connected to the refuse container inner door and two second pistons connected to opposite lateral sides of the hopper plate. The two second pistons are disposed outwardly from the two first pistons so that, in use, the refuse container inner door sweeps refuse from the compactor unit hopper plate into the refuse receiving opening of the container when the hopper plate is in its second position and when the inner door is driven from its open position to its closed position. In this regard, the hopper plate is preferably arcuate in shape having a longitudinal radius substantially equal to a longitudinal height of the refuse container inner door. Also, the hopper plate blocks the compactor refuse loading opening when the hopper plate is in its second position. The refuse container inner door also preferably includes a side wall for clearing refuse away from the container refuse receiving opening as the inner door moves to its closed position to aid in compaction of the refuse within the container. The side wall preferably increases in height in a direction away from the hinged connection of the container inner door so that the side wall will slice into the refuse at the container refuse receiving opening as the inner door moves to its closed position.

In another alternative embodiment, the containerized refuse collection truck includes a cab having a chassis extending rearwardly from the cab and a refuse container removably attached to the chassis and having a refuse receiving opening at a rear end thereof. The chassis includes a protrusion extending upwardly from an upper surface thereof. The refuse container includes an inner door hingedly connected to the refuse container adjacent the refuse receiving opening and further includes a vertically movable locking arm. The locking arm includes a first end having an aperture formed therein and a second end for engagement with the chassis protrusion. The inner door includes a latch for releasable engagement with the locking arm aperture, wherein upon loading the refuse container onto the chassis, the chassis protrusion engages the second end of the locking arm and drives the locking arm upward into an open position whereby the latch of the container inner door is released from engagement with the aperture of the locking arm. Upon removal of the refuse container from the chassis, the locking arm moves downward into a closed position wherein the latch of the container inner door engages the aperture of the locking arm thereby preventing the refuse container inner door from opening.

Preferably, the locking arm includes a spring for biasing the locking arm into its closed position. The locking arm is also preferably movably retained on the outer door which is hingedly connected to a top portion of the rear end of the refuse container. The refuse container also preferably includes an opening in a bottom surface thereof, which is sized to receive the chassis protrusion. The second end of the locking arm protrudes into the bottom opening to engage the chassis protrusion.

A preferred embodiment of a containerized refuse collection truck, as well as other features and advantages of this invention will be apparent from the following detailed description which is to be read in conjunction with the accompanying drawings.

### BRIEF DESCRIPTION OF DRAWINGS

FIG. 1 is a front prospective view of the containerized refuse collection truck of the present invention;

FIG. 2 is a rear perspective view of the containerized refuse collection truck of FIG. 1;

FIG. 3 is a side view of the containerized refuse collection truck of FIG. 1;

FIG. 4 is a perspective view of the container showing the preferred embodiment of the container doors;

FIG. 5 is a rear perspective view of the preferred embodiment of the container doors;

FIG. 5a is a detailed view of the hydraulic lock shown in FIG. 5;

FIGS. 6 and 6a are side views of the rear compactor unit;

FIG. 7 is a perspective view of the rear compactor unit;

FIG. 8 is a perspective view of the preferred embodiment of the removable ejector assembly;

FIG. 9 is a perspective view of the preferred embodiment of the removable ejector assembly;

FIG. 10 is a side view of the ejector assembly shown in FIGS. 8 and 9;

FIG. 11 is a top cross sectional view of an alternate embodiment of the container door and refuse ejector piston in a retracted position;

FIG. 12 is a top cross sectional view of the container shown in FIG. 11 with the ejector piston in an extended position;

FIG. 13 is a top view of the containerized refuse collection truck of FIG. 1;

FIG. 14 is a detailed view of a hydraulic hinge of the container;

FIG. 15 schematically illustrates the operation of the rear compactor of a conventional refuse collection truck;

FIG. 16 illustrates the loading and unloading of the refuse containers of the present invention at a barge dock;

FIG. 17 is a side view of an alternative embodiment of the containerized refuse collection truck formed in accordance with the present invention; and

FIG. 18 is a rear view of the containerized refuse collection truck shown in FIG. 17;

FIG. 19 is a detailed side view of the container door release mechanisms; and

FIG. 20 is a rear view of the container door release mechanisms shown in FIG. 19.

### DETAILED DESCRIPTION OF THE PREFERRED EMBODIMENTS

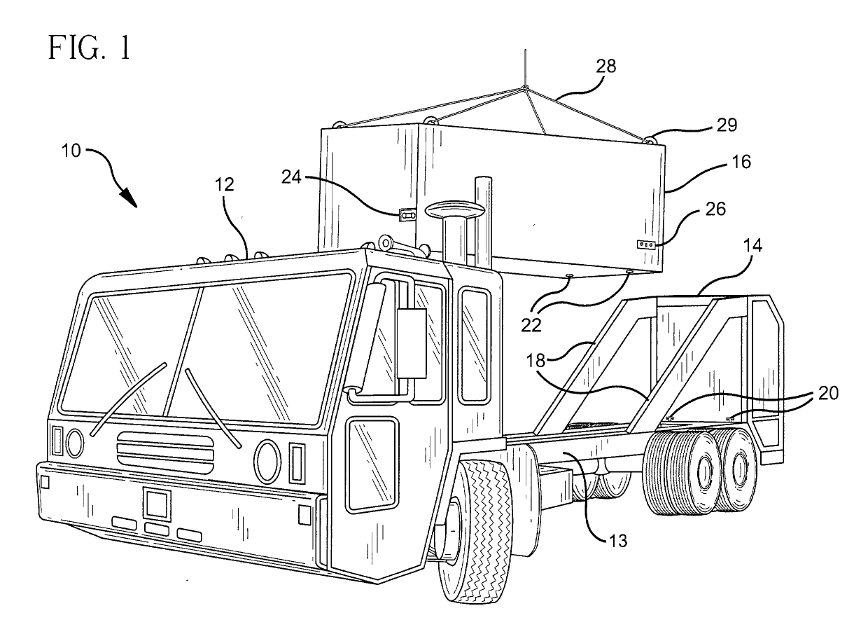

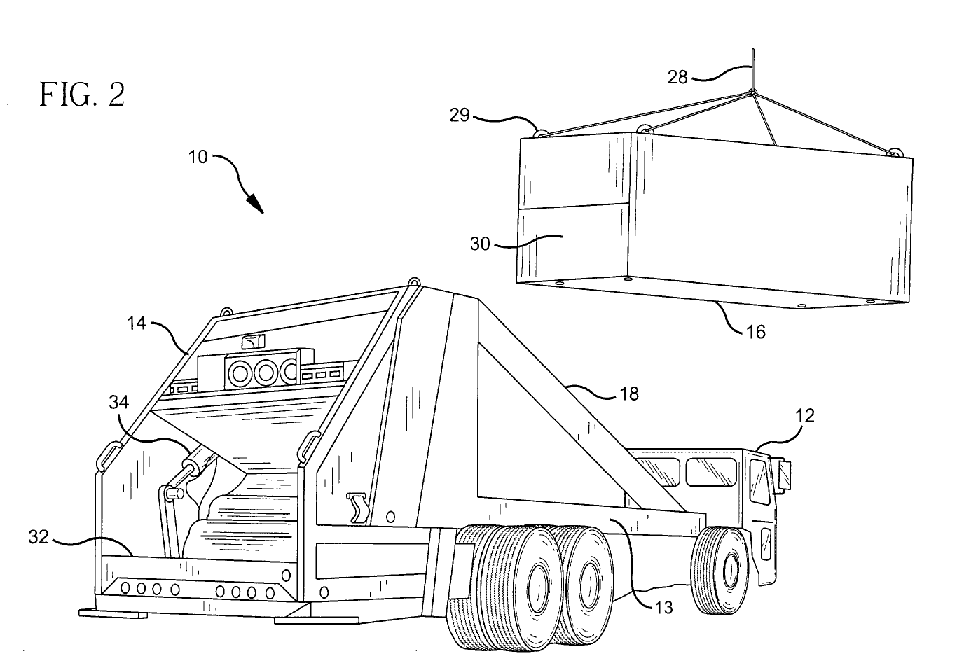

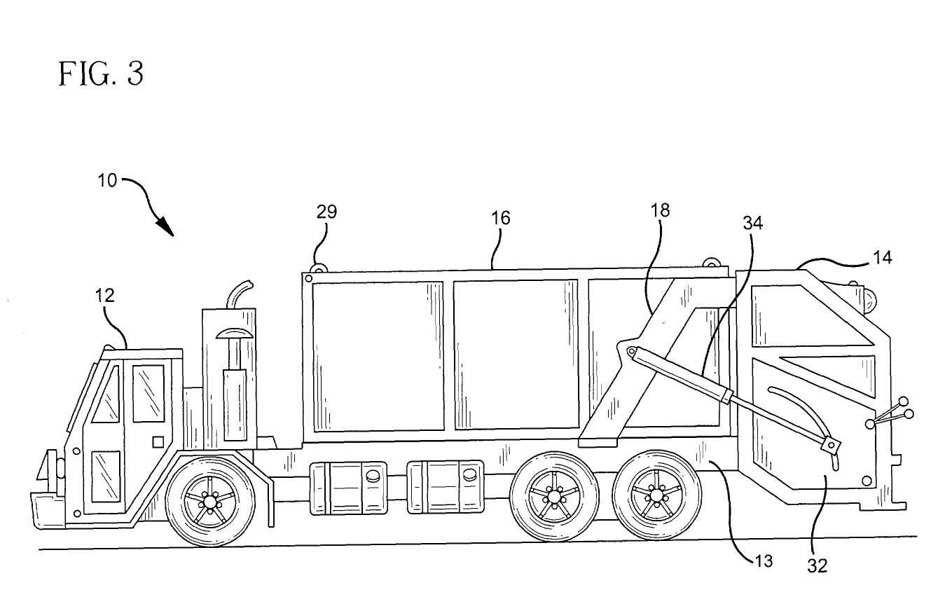

Referring first to FIGS. 1-3, a containerized refuse collection truck according to the present invention is shown. The containerized truck 10 generally includes a conventional cab 12, a chassis 13 extending rearwardly from the cab, a rear compactor unit 14 attached to the rear end of the chassis and a removable refuse container 16 attached to the chassis between the cab and the rear compactor unit.

The cab 12 and chassis 13 may be of any conventional truck design. Positioned at the rear of the chassis 13 is a rear compactor 14, which is similar in design to existing refuse collection truck compactors. Indeed, the containerized truck 10 of the present invention is preferably made by converting a conventional refuse collection truck by removing the central body portion thereof and supporting the rear compactor with structural supports 18 to the chassis 13. Thus, existing hydraulic lines and connections may be utilized.

Preferably, the removable container 16 is secured to the chassis 13 through the use of hydraulic locks 20 fitted into correspondingly sized key-holes 22 provided on the container. The key-holes 22 in the container 16 may be oval in shape and the hydraulic locks 20 may comprise rotatable T-bolts which fit within the oval holes and secure the container to the chassis 13 when rotated 90°. The container 16 is also provided with hydraulic quick-connects 24 and 26, which will be discussed in further detail below. When the container is full, the hydraulic quick-connects 24 and 26 are uncoupled and the hydraulic locks 20 are released. The container 16 may then be removed by a crane with a lifting rig 28 secured to eye-hooks 29 provided on the container.

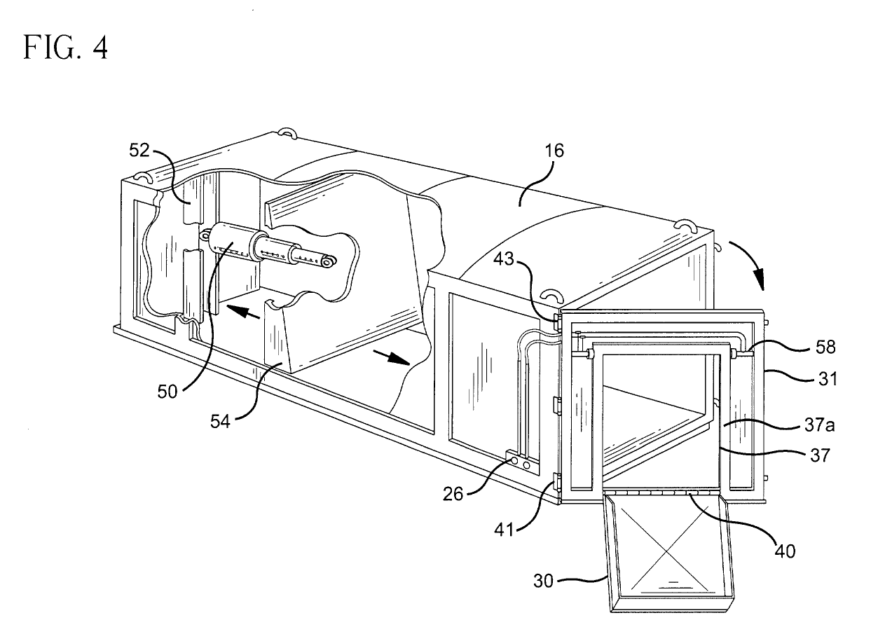

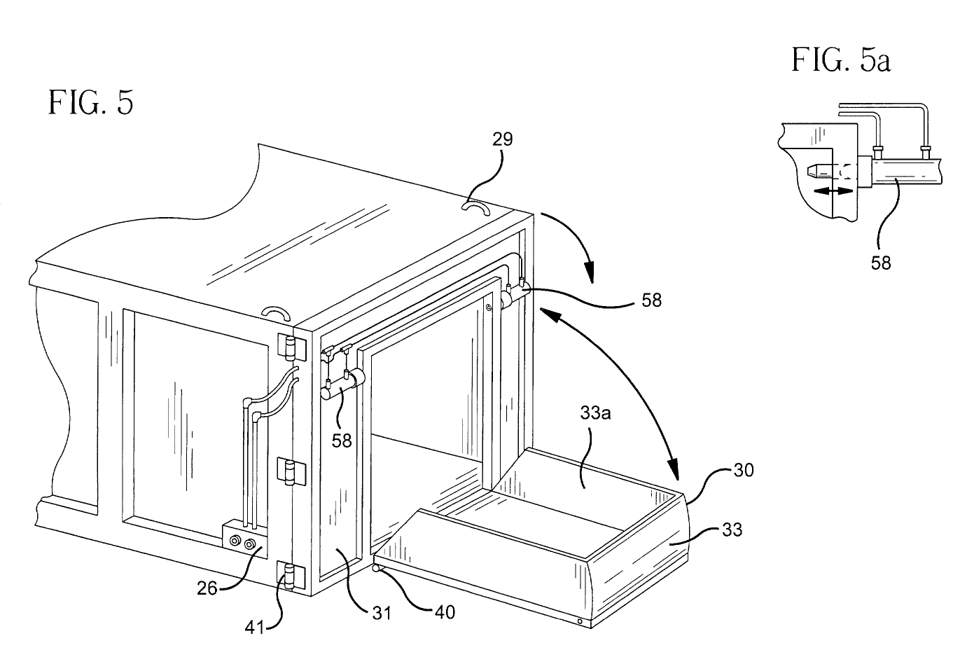

The removable container 16 is made of reinforced steel and is provided with one or more hinged doors opening into the rear compactor 14. In the preferred embodiment as shown in FIGS. 4 and 5, the container 16 is provided with a downwardly swinging hinged inner door 30 and a laterally pivoting hinged outer door 31 connected to the rear of the container by hinges 40 and 41, respectively. The downwardly pivoting inner door 30 swings from an open position for receiving refuse to a closed position for compacting refuse within the container. When the inner door 30 is in its open position, it is received in the bottom well 32 of the rear compactor 14 and garbage may be dumped directly onto the door. The inner door 30 preferably includes three upstanding walls 33 which serve to contain the refuse dumped on the door and to aid in compaction of the refuse within the container 16 when the door closes. When the door 30 is full, it is hydraulically closed to compact the garbage into the container. The sidewalls 33a preferably increase in height in a direction away from the hinge 40 so that the sidewalls will slice into the refuse in the container 16 as the door 30 closes.

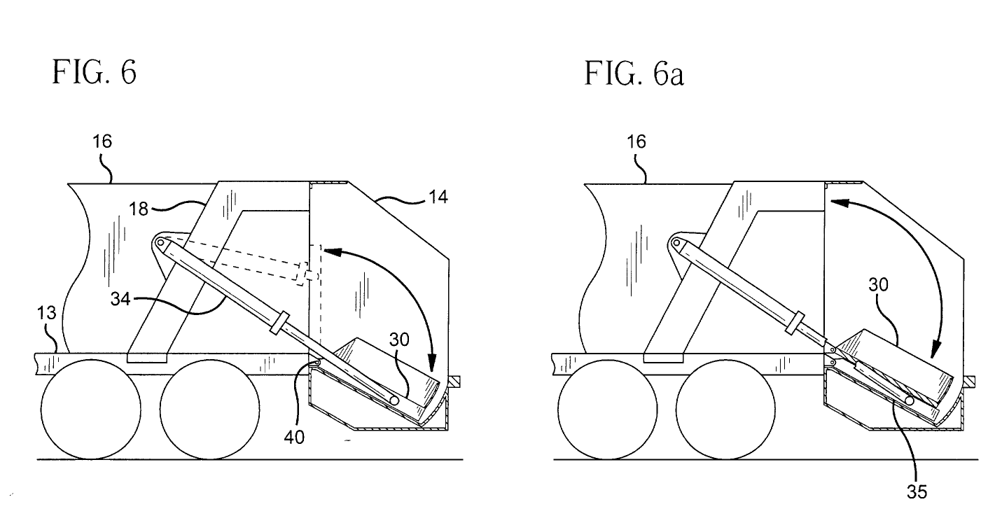

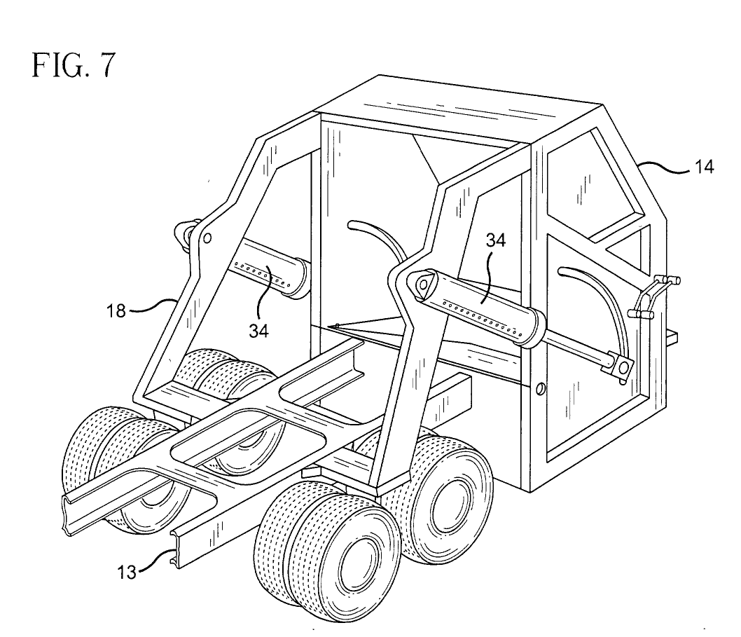

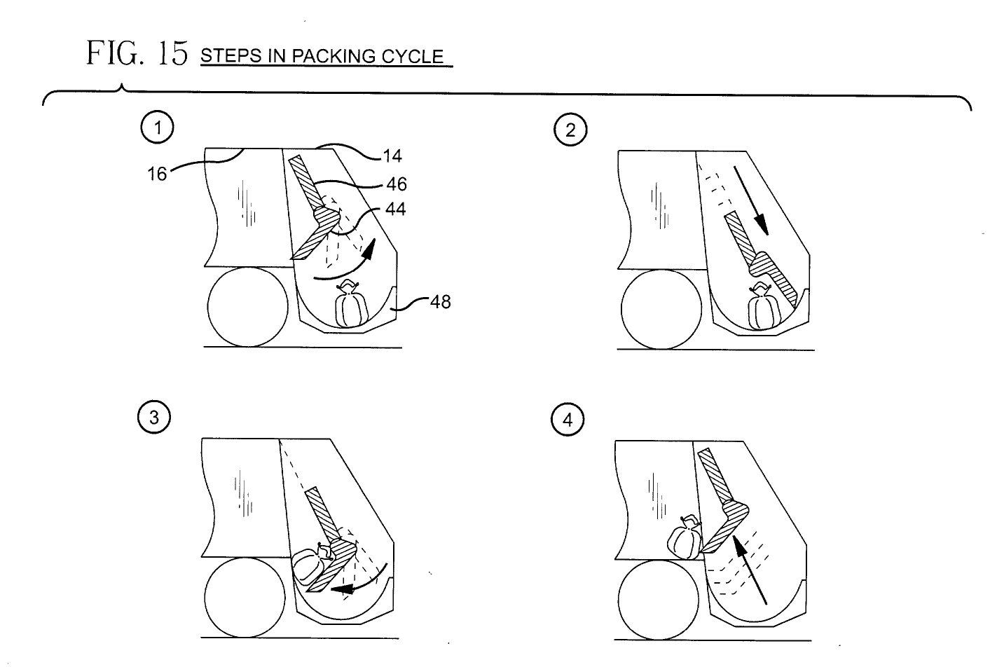

In the preferred embodiment as shown in FIGS. 6 and 7, the inner door 30 is detachably connected to one or more hydraulic pistons 34 of the rear compactor 14. Alternatively, the hydraulic pistons 34 may be permanently connected to a driver door 35 (shown in FIG. 6a) pivotally positioned below the container inner door 30 for driving the container door between its open and closed positions. By using the inner door 30 as the refuse compacting mechanism, only two hydraulic pistons 34 are needed as opposed to the four pistons required in conventional refuse collection trucks to drive a sweeper blade as shown in FIG. 15.

The laterally pivoting hinged outer door 31 is connected to the rear of the container by side hinges 41. The outer door 31 includes an opening 37 including a sealing flange 37a, preferably made from a flexible rubber material, for receiving the inner door 30 and sealing the contents of the container. When the container 16 is to be emptied, the outer door 31 is swung open to the side and the refuse may be ejected from the rear of the container.

The refuse container 16 is further provided with a telescoping hydraulic ejector piston 50 secured at one end to a front wall 52 of the container and having an ejector blade 54 fixed at an opposite end of the piston. As the container 16 begins to be loaded, the ejector piston 50 is in an extended position to provide a biasing force against the loaded refuse and thereby compacting the refuse as it is loaded. During further loading, the ejector piston 50 maintains a constant pressure against the loaded refuse but gradually retracts until the ejector blade 54 is positioned adjacent the front wall 52 of the container 16, when the container is full. When the container is to be emptied, hydraulic lines 56 from an on-site hydraulic system or from a transport truck are connected to the ejector quick connect 24. The telescoping hydraulic ejector piston 50 is activated causing the ejector piston and blade to move away from the front wall 52 of the container thereby causing the refuse to be ejected from the container.

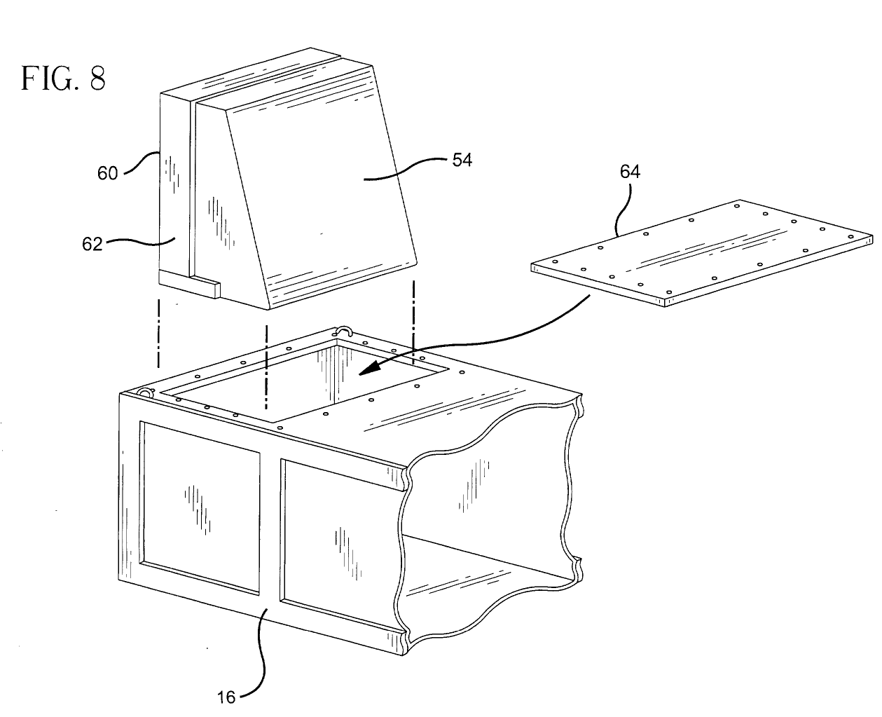

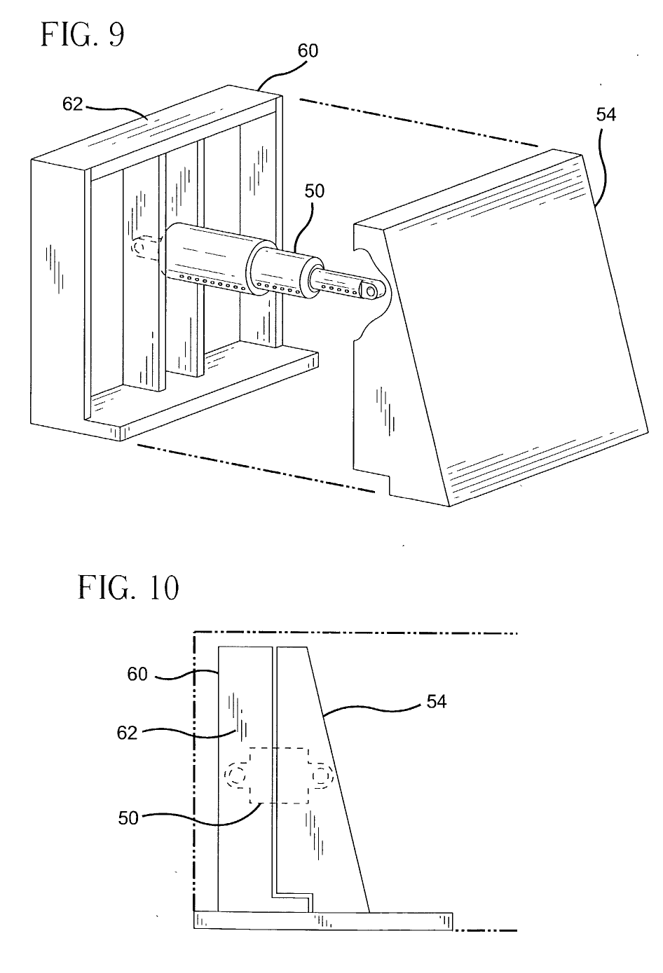

In the preferred embodiment, as shown in FIGS. 8, 9 and 10, the ejector piston 50 and ejector blade 54 take the form of a removable ejector assembly 60. Here, the ejector piston 50 is secured at one end to a frame 62 and at the other end to the ejector blade 54. The frame 62 is then fastened to the front wall 52 and/or the floor of the container 16 by any conventional releasable means. Once secured within the container, operation of the ejector assembly 60 is similar to that described above. The ejector assembly 60 can be removed from the container 16 by opening a panel 64 provided on the container and the ejector assembly can be placed in another container. By providing a removable ejector assembly 60, the costs for each individual container are significantly reduced. Additionally, malfunction of the ejector assembly 60 will not impact use of the container.

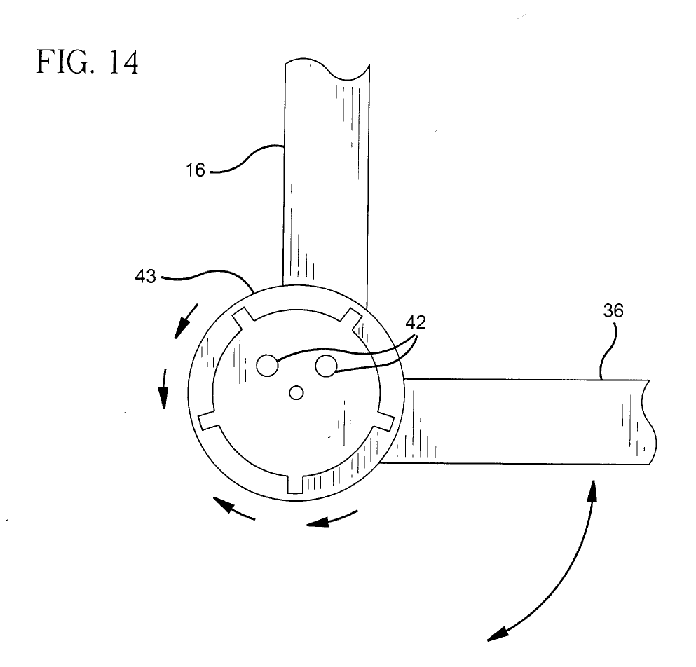

In further alternate embodiments, the container 16 may be provided with its own hydraulic pistons (not shown in FIG. 4), a hydraulic hinge 43 (a typical hydraulic hinge 43 is shown in FIG. 14) and hydraulic locks 58 for securing the inner door 30 to the outer door 31. In these alternate embodiments, hydraulic lines of the cab 12 and chassis 13 are connected to the hydraulic quick connect 26 in order to activate the rear door 30. In each embodiment however, the door 30 acts as the compacting mechanism for packing the garbage into the container. Additionally, the containers may also be provided with a built in wash down system comprising water nozzles provided on the interior walls of the container to clear any loose refuse within the container during dumping and before being returned to the local container transfer station.

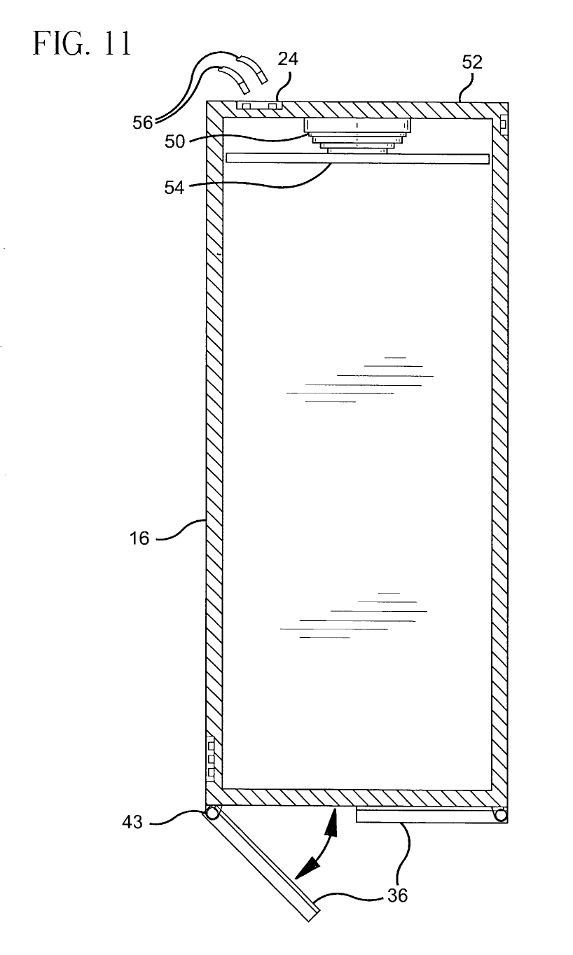

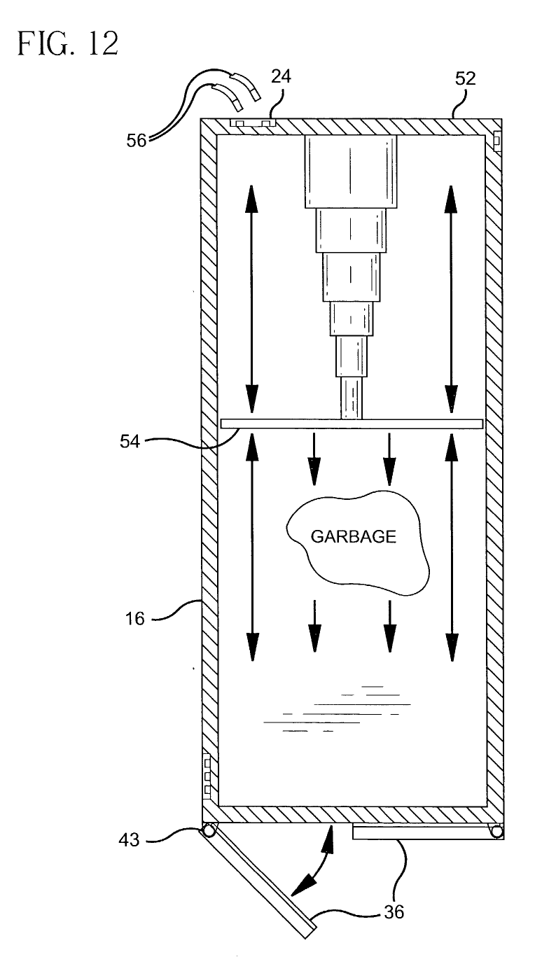

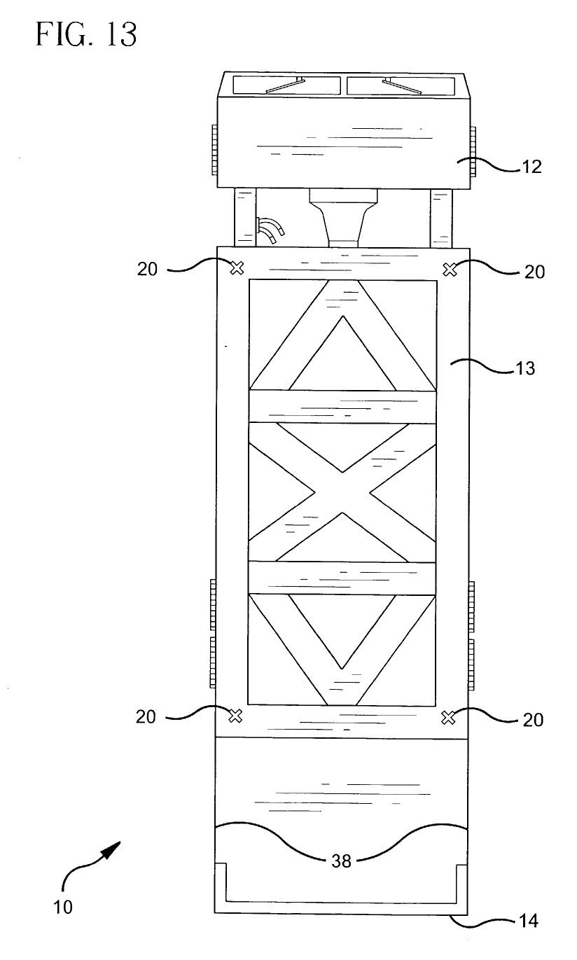

FIGS. 11, 12 and 13 show an alternate embodiment for the rear doors. In this alternate embodiment, two pivoting doors 36 are provided on the sidewalls of the container 16. The side doors 36 may be freely pivoting doors or they may be hydraulically activated through hydraulic door hinges 43 which are connected to the chassis' existing hydraulic lines through quick connects 42 as shown in FIG. 14. Once the container 16 is secured to the chassis 13, the side doors 36 are swung open and are secured in recesses 38 of the rear compactor so as not to interfere with the compactor blades 44 of the rear compactor. FIG. 15 illustrates the operation of a conventional rear compactor assembly comprising a compactor blade 44 and hydraulic pistons 46, which may be utilized with a container 16 having side doors 36. As shown in FIG. 15, garbage is received in the bottom well 48 of the rear compactor and is transported to the container by reciprocating hydraulic pistons 46 and a pivoting hydraulic blade 44. Again, when the container 16 is full, the side doors 36 are closed and secured and the container may be removed from the chassis 13.

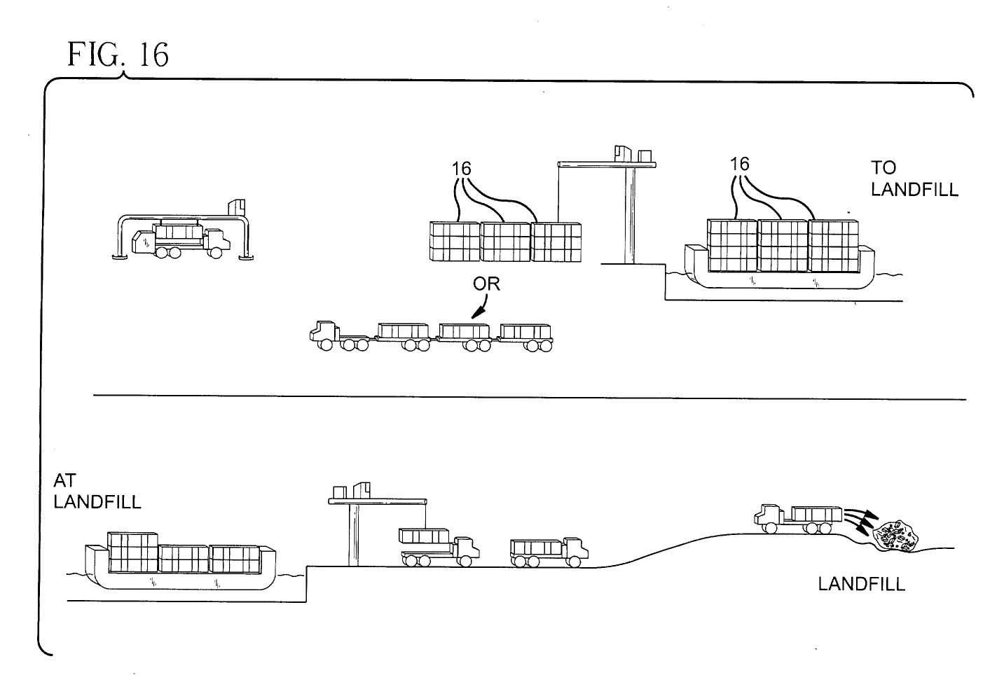

In use, when the refuse container is full, the truck driver may drive to a local container transfer station and the full refuse container may be removed and replaced by an empty container. Thus, the refuse collection truck may continue with its collection without significant interruption along its route. The full containers may be transported from the local container transfer stations by truck or by rail directly to a landfill or to a transport barge, as shown in FIG. 16. The containers may be loaded and stacked directly on the barge and then transferred to transport trucks at the landfill where they are emptied. The emptied containers are then returned to the local container transfer stations to be used again on the refuse collection trucks.

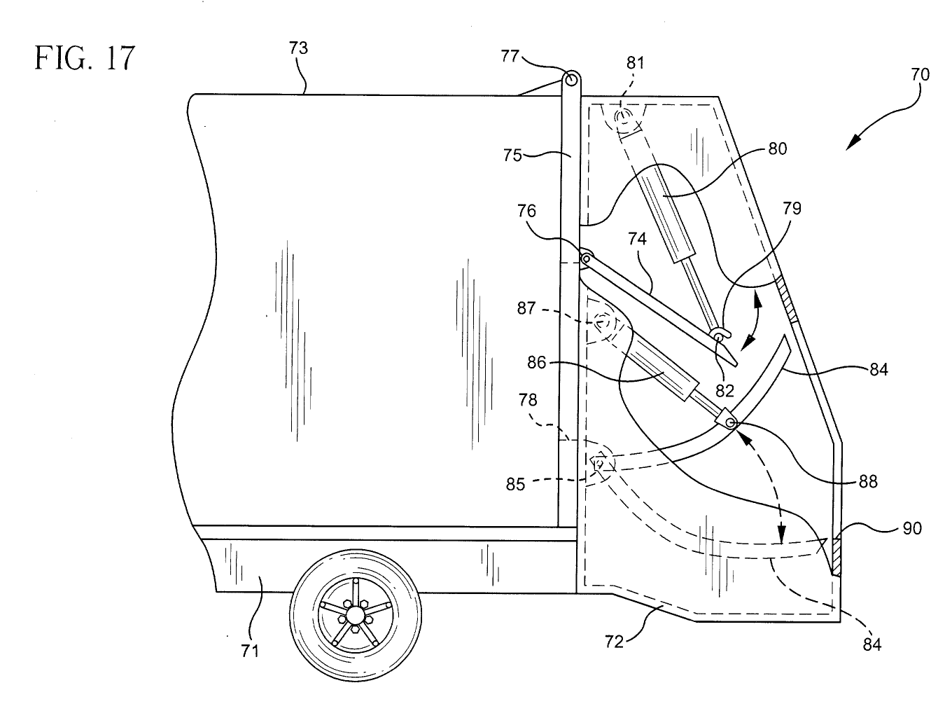

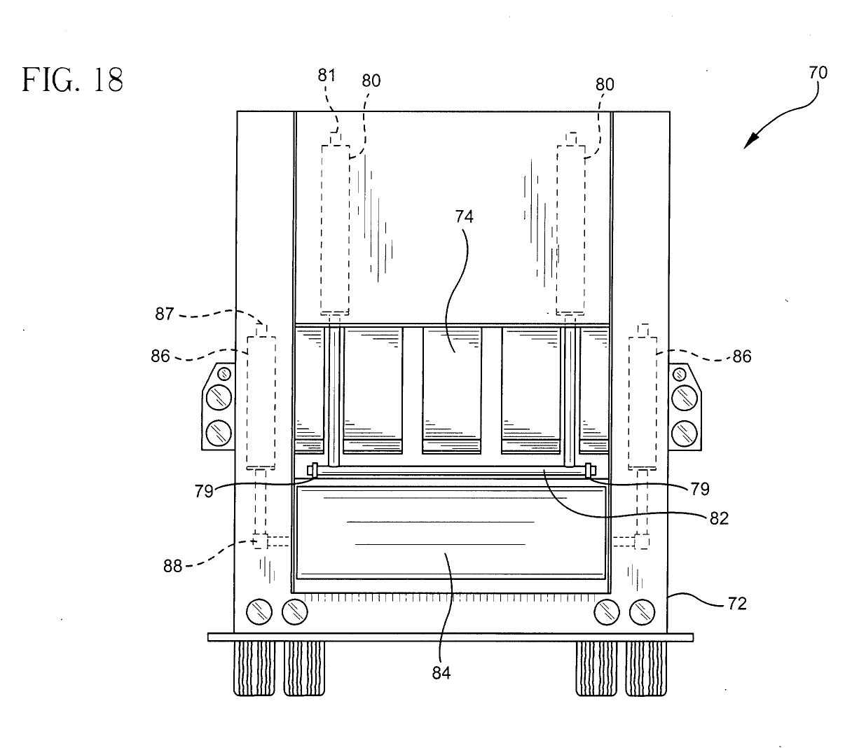

FIGS. 17 and 18 show an alternative embodiment of the containerized refuse collection truck 70 formed in accordance with the present invention. Again, the containerized truck 70 generally includes a conventional cab (not shown in FIGS. 17 and 18), a chassis 71 extending rearwardly from the cab, a rear compactor unit 72 attached to the rear end of the chassis and a removable refuse container 73 attached to the chassis between the cab and the rear compactor unit.

However, the removable container 73 shown in FIGS. 17 and 18 includes an upwardly swinging hinged inner door 74 and an upwardly swinging hinged outer door 75. The upper end of the inner door 74 is connected to the outer door 75 at a hinge 76, while the upper end of the outer door is connected to the rear of the container at a hinge 77. The upwardly pivoting inner door 74 swings from a closed position, wherein it seals the container opening 78, to an open position, wherein it is positioned in the upper portion of the rear compactor 72, and returns to its closed position for compacting refuse into the opening within the container. The inner door 74 preferably includes two arcuate shaped hooks 79 for quick engagement with two inner door hydraulic pistons 80 provided in the compactor unit 72. The hooks 79 preferably face downwardly, (i.e., the openings of the hooks face away from the hinge 76), whereby upon loading the container 73 downwardly onto the chassis 71, the hooks can be easily guided into engagement with the inner pistons 80.

In the preferred embodiment as shown in FIGS. 17 and 18, the compactor unit 72 includes two inner pistons 80 which alternately expand and retract for driving the inner container door 74 open and closed. The inner pistons 80 are pivotably fixed at one end 81 to the inner structure of an upper portion of the compactor unit 72. At their opposite ends, the inner pistons 80 may be connected to a rigid cross-beam 82 for tying the two pistons together and for detachably connecting to the hooks 79 of the inner container door 74.

The compactor unit 72 further includes a pivoting hopper plate 84 pivotably connected to the forward inner structure of a bottom portion of the compactor unit at a hinge 85. The hopper plate 84 is preferably arcuate in shape having a longitudinal radius roughly equal to the longitudinal height of the inner container door 74. The hopper plate 84 is connected to two outer hopper plate pistons 86 at its lateral sides for driving the hopper plate up and down within the bottom well portion of the compactor unit 72. The outer pistons 86 are pivotably fixed at one end 87 to the compactor unit 72 and pivotably connected at its opposite end 88 to the hopper plate 84. Referring specifically to FIG. 18, the outer pistons 86 are positioned outwardly from the inner pistons 80 in the compactor unit 72 to allow free independent movement of the inner container door 74 and the hopper plate 84.

In operation, upon loading refuse into the compactor unit 72, the inner pistons 80 retract to lift the inner container door 74 to its fully open position, wherein the inner door is disposed in the upper portion of the compactor unit and is clear of the compactor refuse loading opening 90. The outer pistons 86 expand to position the hopper plate 84 to its full downward position (shown in dashed lines in FIG. 17) where it too is clear of the compactor loading opening 90. In this position, refuse can be loaded directly on the hopper plate 84 through the compactor opening 90. Once the hopper plate 84 is fully loaded with refuse, the outer pistons 86 retract to pull the hopper plate upward to a position wherein the hopper plate blocks the compactor opening 90. The inner pistons 80 then expand to drive the inner container door 74 through an arc defined by its pivot point 76. As the inner container door 74 pivots on its hinge 76, it travels along the arcuate shaped hopper plate 84 to sweep refuse loaded on the hopper plate into the container opening 78. The inner pistons 80 further drive the inner container door 74 to its fully closed position for compacting the refuse into the container 73. Once the refuse has been swept off the hopper plate 84 and compacted into the container 73, the inner pistons 80 again retract bringing the inner container door to its fully open position. The outer pistons 86 then expand to bring the hopper plate 84 to its down position to repeat the cycle.

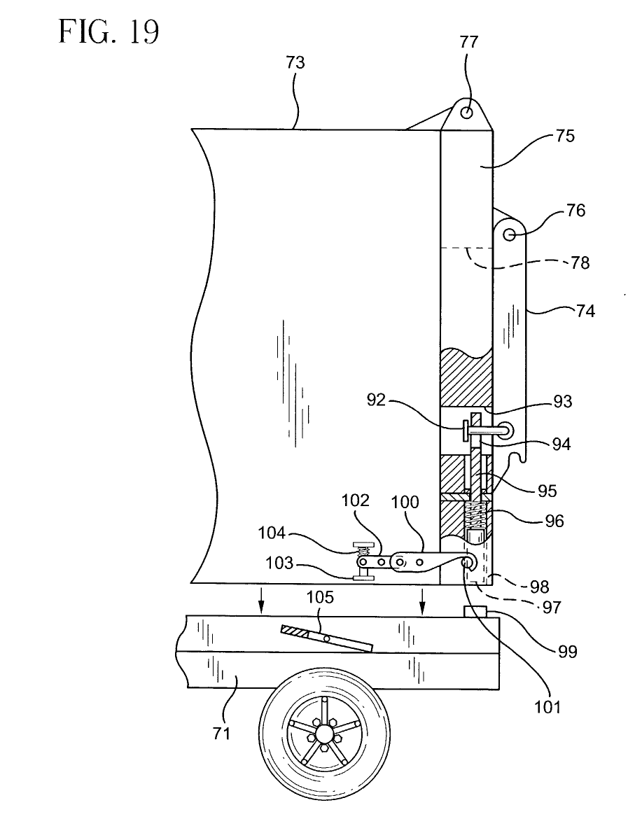

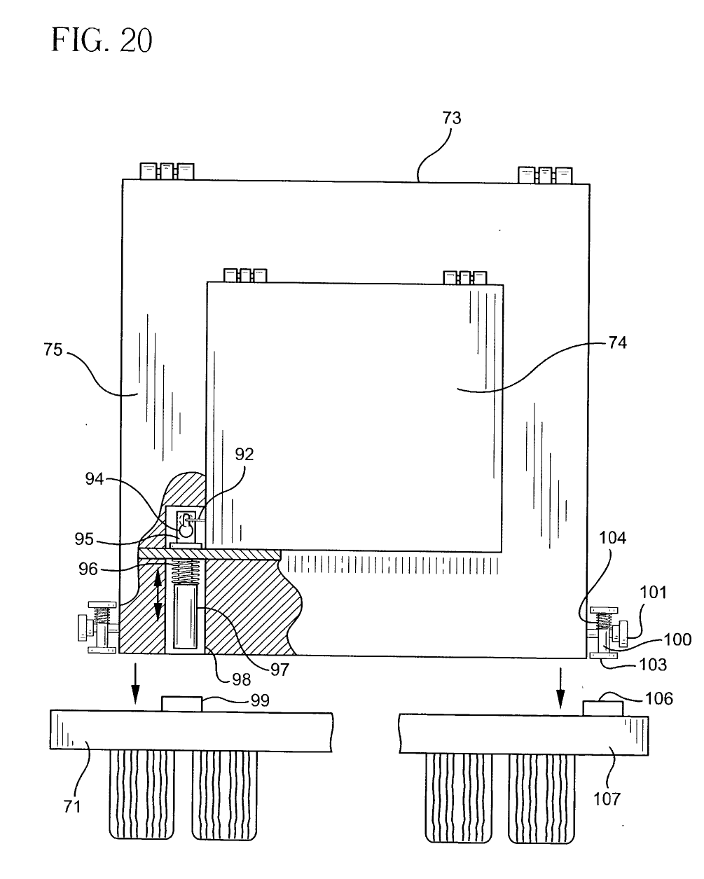

Referring now to FIGS. 19 and 20, the removable container 73 further preferably includes container door self-locking and automatic-release mechanisms. The inner container door 74 preferably includes a latch 92 fixed on one or both lateral sides of the door. The latch 92 extends into an opening 93 near the refuse opening 78 in the outer door 75 when the inner door 74 is fully closed. The latch 92 of the inner door 74 is received in an aperture 94 formed in one end of a vertically movable locking arm 95. The aperture 94 of the locking arm 95 is sized and shaped to engage and retain the latch 92 of the inner door 74 when the locking arm is in a downward position, yet it releases the latch when the locking arm is in an upward position. The locking arm 95 is retained within the inner structure of the outer container door 75 and is biased in the normally downward position by a spring 96 so that the inner door 74 is normally held closed by the latch 92.

The end 97 of the locking arm 95 opposite the latch opening 94 protrudes through an opening or recess 98 formed in the bottom of the outer container door 75. Preferably, the end 97 of the locking arm 95 does not extend beyond the bottom edge of the outer container door to prevent inadvertent activation of the release mechanism. The opening or recess 97 is sized to mate with a protrusion or boss 99 provided on the chassis 71 of the refuse truck. As the refuse container 73 is positioned and lowered on the chassis 71, the protruding boss 99 contacts the end 97 of the locking arm 95 extending into the recess 98 and pushes the locking arm upward. As the locking arm 95 moves upward, the aperture 94 of the locking arm moves out of engagement with the latch 92 of the inner door 74, which automatically releases the inner door. Conversely, when the container 73 is removed from the chassis 71, the protruding boss 99 on the chassis breaks contact with the locking arm 95 and the locking arm is forced to return to its normal downward position by the spring 96. As the locking arm 95 moves downward, the aperture 94 of the locking arm reengages the latch 92 of the inner door 74. Thus, upon removal of the container 73 from the chassis 71, the inner door 74 is automatically locked in a closed position.

In a similar fashion, the outer container door 75 can be provided with an automatic locking and release mechanism. Still referring to FIGS. 19 and 20, the container 73 is shown having a pivotable hook 100 attached to the side of the container wall which engages a latch 101 provided on the side of the outer container door 75. The hook 100 is pivoted by a locking lever 102 having an engagement foot 103. When the engagement foot 103 is pushed upward, the locking lever 102 pivots the hook 100 out of engagement with the latch 101 provided on the outer container door 75. Preferably, a spring 104 is provided to bias the engagement foot 103 downward so that the hook 100 is normally engaged with the latch 101 to retain the outer door 75 in a normally closed position. The locking lever 102 can be manually engaged by a handle mechanism 105 provided on the chassis 71, as shown in FIG. 19, or it can be similarly activated automatically, as described above, by a raised boss 106, which can be provided on a chassis 107 of a dedicated refuse dumping truck or can be provided at a dumping station platform. As the container 73 is lowered onto the chassis 107, or onto a dumping platform, the raised boss 106 engages the engagement foot 103 of the locking lever 102 to pivot the hook 100 out of engagement with the latch 101 on the outer container door 75. Thus, upon loading the container 73 onto the chassis 107, or a dumping station platform, the outer container door 75 is automatically released. Conversely, when the container 73 is lifted from the chassis 107, or the dumping platform, the spring 104 returns the locking lever 100 to its normally closed position wherein the hook 100 engages the latch 101 to again lock the outer door 75 in a closed position.

As a result of the present invention, an efficient refuse collection system with improved sanitary conditions is provided. Down time of the refuse collection truck is minimized by providing a removable container whereby the collection truck can continue on its route rather than transporting and dumping the refuse at a dumping site. Moreover, intermediate dumping sites and their associated expensive heavy equipment are eliminated. Finally, transporting containerized refuse eliminates the unsanitary problems with respect to odors, spillage and the congregation of seagulls and vermin.

Although the illustrative embodiments of the present invention have been described herein with reference to the accompanying drawings, it is to be understood that the invention is not limited to those precise embodiments and that various other changes and modifications may be effected therein by one skilled in the art without departing from the scope or spirit of the invention.

What is claimed is:

1. A refuse collection truck comprising:
a cab having a chassis extending rearwardly from said cab;
a refuse container removably attached to said chassis, said refuse container including a refuse receiving opening at a rear end thereof and an inner door hingedly connected to said container above said refuse receiving opening; and
a compactor unit attached to a rear end of said chassis, said compactor unit including a hopper plate, a first piston and a second piston, said hopper plate being hingedly connected to a bottom portion of said compactor unit below said refuse receiving opening of said refuse container, said first piston being connected to said refuse container inner door for driving said refuse container inner door between an open position and a closed position, thereby alternately opening and closing said refuse receiving opening of said refuse container, and said second piston being connected to said hopper plate for driving said hopper plate between a first position for receiving refuse on said hopper plate and a second position for loading refuse into said container refuse receiving opening.

2. A refuse collection truck as defined by claim 1, wherein said refuse container further includes an outer door hingedly connected to a top portion of said rear end of said refuse container, said refuse container inner door being hingedly connected to said outer door.

3. A refuse collection truck as defined by claim 1, wherein the refuse container inner door includes a hook for detachable connection with said first piston of said compactor unit.

4. A refuse collection truck as defined by claim 3, wherein said hook faces downwardly away from said hinged connection of said inner door, whereby upon downward loading of said refuse container onto said chassis, said hook engages said first piston of said compactor unit.

5. A refuse collection truck as defined by claim 1, wherein said compactor unit includes two first pistons connected to said refuse container inner door and two second pistons connected to opposite lateral sides of said hopper plate, said two second pistons being disposed outwardly from said two first pistons.

6. A refuse collection truck as defined by claim 1, wherein said refuse container inner door sweeps refuse from said compactor unit hopper plate into said refuse receiving opening of said container when said hopper plate is in said second position and when said inner door is driven from said open position to said closed position.

7. A refuse collection truck as defined by claim 1, wherein said compactor unit hopper plate is arcuate in shape.

8. A refuse collection truck as defined by claim 7, wherein said compactor unit hopper plate has a longitudinal radius substantially equal to a longitudinal height of said refuse container inner door.

9. A refuse collection truck as defined by claim 1, wherein said compactor unit includes a refuse loading opening, said hopper plate blocking said compactor refuse loading opening when said hopper plate is in said second position.

10. A refuse collection truck as defined by claim 1, wherein said refuse container inner door includes a side wall for clearing refuse away from said container refuse receiving opening as said inner door moves to said closed position to aid in compaction of said refuse within said container.

11. A refuse collection truck as defined by claim 10, wherein said side wall increases in height in a direction away from said hinged connection of said container inner door so that said side wall will slice into the refuse at said container refuse receiving opening as said inner door moves to said closed position.

12. A refuse collection truck as defined by claim 1, wherein:
said chassis includes a protrusion extending upwardly from an upper surface thereof;
said refuse container includes a vertically movable locking arm including a first end having an aperture formed therein and a second end for engagement with said chassis protrusion; and
said refuse container inner door includes a latch for releasable engagement with said locking arm aperture,
wherein upon loading said refuse container onto said chassis, said chassis protrusion engages said second end of said locking arm and drives said locking arm upward into an open position wherein said latch of said container inner door is released from engagement with said aperture of said locking arm, and wherein upon removal of said refuse container from said chassis, said locking arm moves downward into a closed position wherein said latch of said container inner door engages said aperture of said locking arm thereby preventing said refuse container inner door from opening.

13. A refuse collection truck as defined by claim 12, wherein said locking arm includes a spring for biasing said locking arm into said closed position.

14. A refuse collection truck as defined by claim 12, wherein said refuse container further includes an outer door hingedly connected to a top portion of said rear end of said refuse container, said refuse container inner door being hingedly connected to said outer door and said locking arm being movably retained on said outer door.

15. A refuse collection truck as defined by claim 12, wherein said refuse container includes an opening in a bottom surface thereof, said opening being sized to receive said chassis protrusion, and said second end of said locking arm protruding into said opening for engagement with said chassis protrusion.

16. A refuse collection truck comprising:
a cab having a chassis extending rearwardly from said cab, said chassis including a protrusion extending upwardly from an upper surface thereof; and
a refuse container removably attached to said chassis and having a refuse receiving opening at a rear end thereof, said refuse container further comprising:
a vertically movable locking arm including a first end having an aperture formed therein and a second end for engagement with said chassis protrusion; and
an inner door hingedly connected to said refuse container adjacent said refuse receiving opening, said inner door including a latch for releasable engagement with said locking arm aperture,
wherein upon loading said refuse container onto said chassis, said chassis protrusion engages said second end of said locking arm and drives said locking arm upward into an open position wherein said latch of said container inner door is released from engagement with said aperture of said locking arm, and wherein upon removal of said refuse container from said chassis, said locking arm moves downward into a closed position wherein said latch of said container inner door engages said aperture of said locking arm thereby preventing said refuse container inner door from opening.

17. A refuse collection truck as defined by claim 16, wherein said locking arm includes a spring for biasing said locking arm into said closed position.

18. A refuse collection truck as defined by claim 16, wherein said refuse container further includes an outer door hingedly connected to a top portion of said rear end of said refuse container, said refuse container inner door being hingedly connected to said outer door and said locking arm being movably retained on said outer door.

19. A refuse collection truck as defined by claim 16, wherein said refuse container includes an opening in a bottom surface thereof, said opening being sized to receive said chassis protrusion, and said second end of said locking arm protruding into said opening for engagement with said chassis protrusion.

20. A refuse collection truck as defined by claim 16, further comprising a compactor unit attached to a rear end of said chassis, said compactor unit including a first piston connected to said refuse container inner door for driving said refuse container inner door between an open position and a closed position thereby alternately opening and closing said refuse receiving opening of said refuse container.

21. A refuse collection truck as defined by claim 20, wherein said refuse container inner door includes a hook for detachable connection with said first piston of said compactor unit.

22. A refuse collection truck as defined by claim 20, wherein said compactor unit further comprises:
a hopper plate hingedly connected to a bottom portion of said compactor unit below said refuse receiving opening of said refuse container; and
a second piston connected to said hopper plate for driving said hopper plate between a first position for receiving refuse on said hopper plate and a second position for loading refuse into said refuse receiving opening of said refuse container.

23. A refuse collection truck as defined by claim 22, wherein said refuse container inner door sweeps refuse from said compactor unit hopper plate into said refuse receiving opening of said container when said hopper plate is in said second position and when said inner door is driven from said open position to said closed position.

24. A refuse collection truck as defined by claim 22, wherein said compactor unit includes a refuse loading opening, said hopper plate blocking said compactor refuse loading opening when said hopper plate is in said second position.

25. A refuse collection truck as defined by claim 22, wherein said compactor unit hopper plate is arcuate in shape.

26. A refuse collection truck as defined by claim 25, wherein said compactor unit hopper plate has a longitudinal radius substantially equal to a longitudinal height of said refuse container inner door.
